(19) United States
(12) Patent Application Publication
(10) Pub. No.: US 2024/0056152 A1
(43) Pub. Date: Feb. 15, 2024

(54) CSI MEASUREMENT AND REPORT WITH OPERATION STATE ADAPTATION

(71) Applicant: Samsung Electronics Co., Ltd., Suwon-si, Gyeonggi-do (KR)

(72) Inventors: Jeongho Jeon, San Jose, CA (US); Aristides Papasakellariou, Houston, TX (US)

(21) Appl. No.: 18/359,730

(22) Filed: Jul. 26, 2023

Related U.S. Application Data
(60) Provisional application No. 63/396,854, filed on Aug. 10, 2022.

(51) Int. Cl. H04B 7/06; H04L 5/00; H04W 24/10; H04W 52/54

(52) U.S. Cl. CPC H04B 7/0626; H04L 5/0048; H04W 24/10; H04W 52/54

(57) ABSTRACT

Methods and apparatuses for measurement enhancement with network operation states in a wireless communication system. A method for a user equipment (UE) to report channel state information (CSI) includes receiving first information related to transmissions, from a base station (BS), of first reference signals (RSs) associated with respective first operation states on a first cell, second information related to computing first CSI reports from respective receptions of the first RSs on the first cell, and the first RSs based on the first information. The first RSs include channel state information reference signals (CSI-RS) or synchronization signals. The method further includes determining, based on the second information, the first CSI reports corresponding to the respective receptions of the first RSs on the first cell and transmitting a channel with the first CSI reports.

### CROSS-REFERENCE TO RELATED APPLICATIONS AND CLAIM OF PRIORITY

The present application claims priority to U.S. Provisional Patent Application No. 63/396,854, filed on Aug. 10, 2022. The contents of the above-identified patent documents are incorporated herein by reference.

### TECHNICAL FIELD

The present disclosure relates generally to wireless communication systems and, more specifically, the present disclosure relates to CSI measurement and report with operation state adaptation in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to CSI measurement and report with operation state adaptation in a wireless communication system.

In one embodiment, a method for a user equipment (UE) to report channel state information (CSI) is provided. The method includes receiving first information related to transmissions, from a base station (BS), of first reference signals (RSs) associated with respective first operation states on a first cell, second information related to computing first CSI reports from respective receptions of the first RSs on the first cell, and the first RSs based on the first information. The first RSs include channel state information reference signals (CSI-RS) or synchronization signals. The method further includes determining, based on the second information, the first CSI reports corresponding to the respective receptions of the first RSs on the first cell and transmitting a channel with the first CSI reports.

In another embodiment, a UE is provided. The UE includes a transceiver configured to receive: first information related to transmissions, from a BS, of first RSs associated with respective first operation states on a first cell, second information related to computing first CSI reports from respective receptions of the first RSs on the first cell, and the first RSs based on the first information. The first RSs includes CSI-RS or synchronization signals. The BS further includes a processor operably coupled to the transceiver. The processor is configured to determine, based on the second information, the first CSI reports corresponding to the respective receptions of the first RSs on the first cell. The transceiver further configured to transmit a channel with the first CSI reports.

In yet another embodiment, a BS is provided. The BS includes a transceiver configured to transmit first information related to transmissions of first RSs associated with respective first operation states on a first cell; transmit second information related to computing first CSI reports from respective receptions of the first RSs on the first cell; transmit the first RSs based on the first information; and receive a channel with the first CSI reports. The first RSs includes CSI-RS or synchronization signals. The first CSI reports correspond to the first RSs on the first cell and are based on the second information.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of layer 1 (L1) CSI measurement according to embodiments of the present disclosure;

FIG. 7 illustrates an example of timing diagram of network (NW) operation state transition according to embodiments of the present disclosure;

FIG. 8 illustrates a flowchart of NW procedure to indicate and activate NW operation states according to embodiments of the present disclosure;

FIG. 9 illustrates a flowchart of UE procedure to receive and activate NW operation states according to embodiments of the present disclosure;

FIG. 10 illustrates an example of measurement enhancement with NW operation states according to embodiments of the present disclosure;

FIG. 11 illustrates a flowchart of UE procedure for L1 measurement enhancement with NW operation states according to embodiments of the present disclosure;

FIG. 12 illustrates an example of measurement enhancement with NW operation states according to embodiments of the present disclosure;

FIG. 13 illustrates a flowchart of UE procedure for layer 3 (L3) measurement enhancement with NW operation states for synchronization signal block (SSB)-based L1 measurements according to embodiments of the present disclosure; and

FIG. 14 illustrates a flowchart of UE procedure for L3 measurement enhancement with NW operation states for CSI-RS-based L1 measurements according to embodiments of the present disclosure.

### DETAILED DESCRIPTION

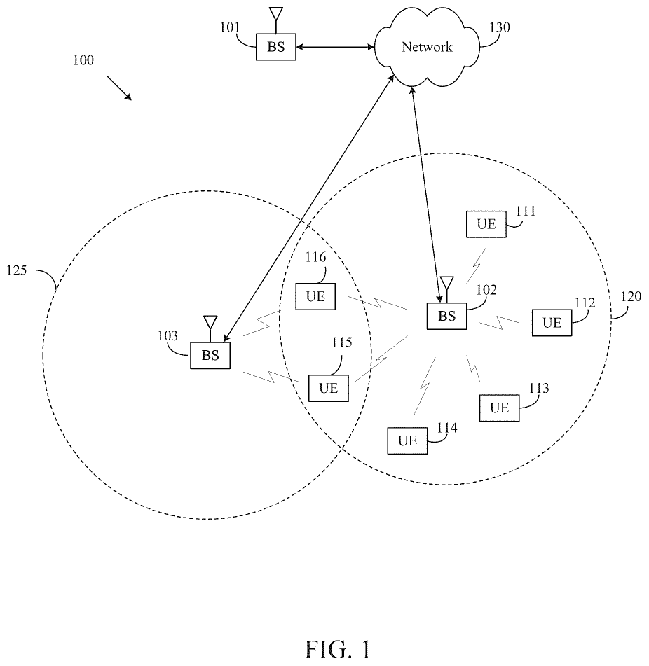

FIG. 1 through FIG. 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v17.2.0, “NR; Physical channels and modulation”; 3GPP TS 38.212 v17.2.0, “NR; Multiplexing and Channel coding”; 3GPP TS 38.213 v17.2.0, “NR; Physical Layer Procedures for Control”; 3GPP TS 38.214 v17.2.0, “NR; Physical Layer Procedures for Data”; 3GPP TS 38.215 v17.1.0, “NR; Physical layer measurements”; 3GPP TS 38.321 v17.1.0, “NR; Medium Access Control (MAC) protocol specification”; 3GPP TS 38.331 v17.1.0, “NR; Radio Resource Control (RRC) Protocol Specification”; and 3GPP TS 38.133 v17.6.0, “NR; Requirements for support of radio resource management.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for performing CSI measurement and report with operation state adaptation in a wireless communication system. In certain embodiments, and one or more of the gNBs 101-103 includes circuitry, programing, or a combination thereof, for supporting CSI measurement and report with operation state adaptation in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

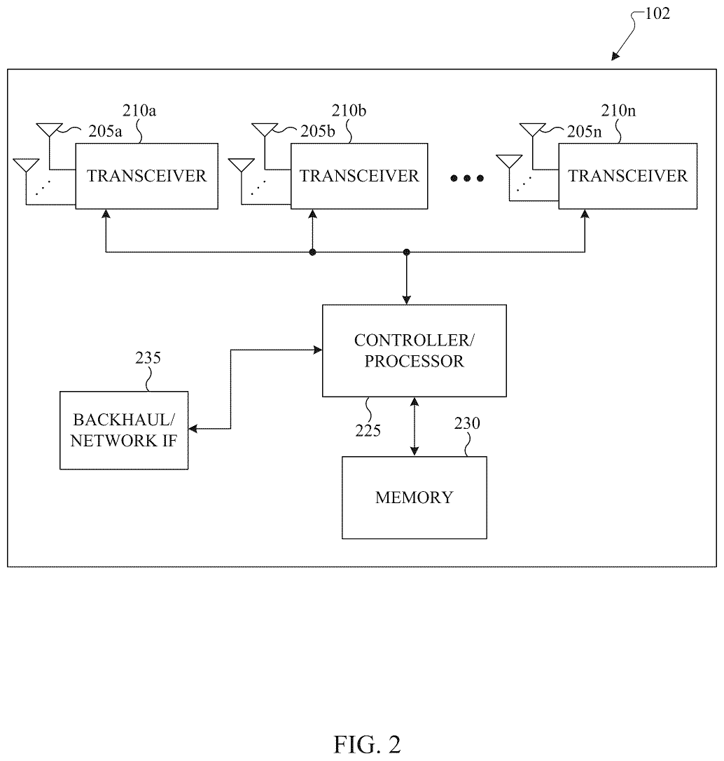

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting CSI measurement and report with operation state adaptation in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

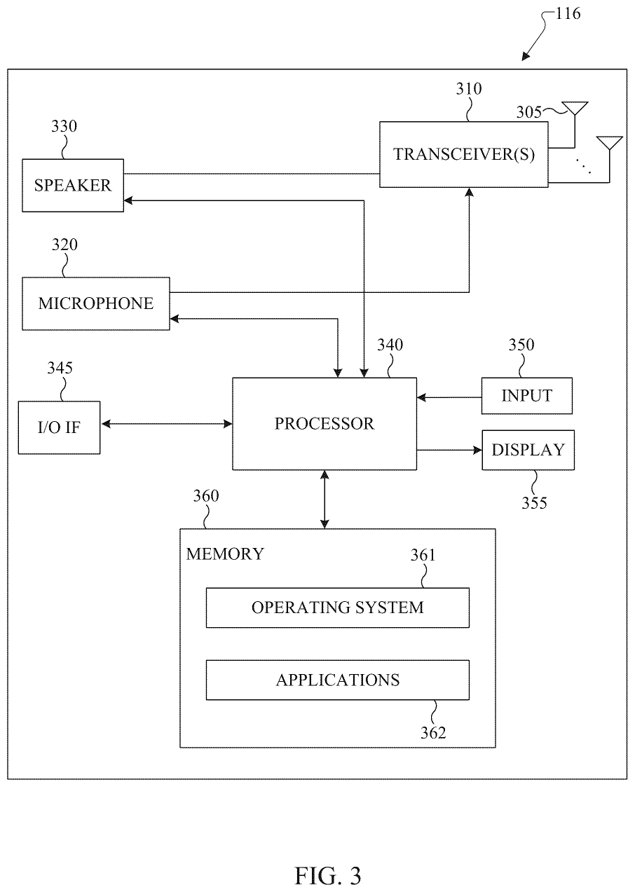

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for CSI measurement and report with operation state adaptation in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

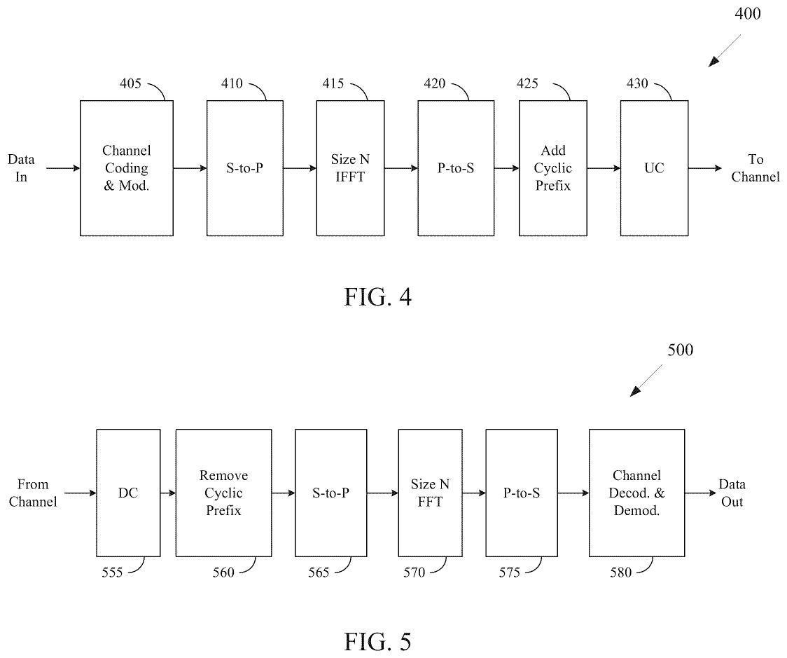

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support CSI measurement and report with operation state adaptation in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

Downlink (DL) transmissions or uplink (UL) transmissions can be based on an orthogonal frequency division multiplexing (OFDM) waveform including a variant using DFT precoding that is known as DFT-spread-OFDM that is typically applicable to UL transmissions.

In the present disclosure, subframe (SF) refers to a transmission time unit for the LTE radio access technology (RAT) and slot refers to a transmission time unit for an NR RAT. For example, the slot duration can be a sub-multiple of the SF duration. NR can use a different DL or UL slot structure than an LTE SF structure. Differences can include a structure for transmitting physical downlink control channels (PDCCHs), locations and structure of demodulation reference signals (DM-RS), transmission duration, and so on. Further, eNB refers to a base station serving UEs operating with LTE RAT and gNB refers to a base station serving UEs operating with NR RAT. Exemplary embodiments consider a same numerology, that includes a sub-carrier spacing (SCS) configuration and a cyclic prefix (CP) length for an OFDM symbol, for transmission with LTE RAT and with NR RAT. In such case, OFDM symbols for the LTE RAT as same as for the NR RAT, a subframe is same as a slot and, for brevity, the term slot is subsequently used in the remaining of the present disclosure.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration y as 2-15 kHz. A unit of one sub-carrier over one symbol is referred to as resource element (RE). A unit of one RB over one symbol is referred to as physical RB (PRB).

Among various physical layer measurements performed by a UE as illustrated in 3GPP standard specification, a set of measurements related to this disclosure are described in the following. In the following, for brevity, a synchronization signal and primary broadcast channel block (SS/PBCH block) is referred to as SSB.

CSI may consist of Channel Quality Indicator (CQI), precoding matrix indicator (PMI), CSI-RS resource indicator (CRI), SS/PBCH Block Resource indicator (SSBRI), layer indicator (LI), rank indicator (RI), L1-reference signal received power (L1-RSRP), L1-signal-to-noise and interference ratio (L1-SINR) or Capability[Set] Index according to TS 38.214 3GPP standard specification.

SS reference signal received power (SS-RSRP) is defined as the linear average over the power contributions (in [W]) of the resource elements that carry secondary synchronization signals. The measurement time resource(s) for SS-RSRP are confined within SS/PBCH block measurement time configuration (SMTC) window duration. If SS-RSRP is used for L1-RSRP as configured by reporting configurations as defined in TS 38.214 3GPP standard specification, the measurement time resources(s) restriction by SMTC window duration is not applicable.

For SS-RSRP determination demodulation reference signals for physical broadcast channel (PBCH) and, if indicated by higher layers, CSI reference signals in addition to secondary synchronization signals may be used. SS-RSRP using demodulation reference signal for PBCH or CSI reference signal may be measured by linear averaging over the power contributions of the resource elements that carry corresponding reference signals considering power scaling for the reference signals as defined in TS 38.213 3GPP standard specification. If SS-RSRP is not used for L1-RSRP, the additional use of CSI reference signals for SS-RSRP determination is not applicable. SS-RSRP may be measured only among the reference signals corresponding to SSBs with the same SSB index and the same physical-layer cell identity. If SS-RSRP is not used for L1-RSRP and higher-layers indicate certain SSBs for performing SS-RSRP measurements, then SS-RSRP is measured only from the indicated set of SSBs.

For frequency range 1, the reference point for the SS-RSRP may be the antenna connector of the UE. For frequency range 2, SS-RSRP may be measured based on the combined signal from antenna elements corresponding to a given receiver branch. For frequency range 1 and 2, if receiver diversity is in use by the UE, the reported SS-RSRP value may not be lower than the corresponding SS-RSRP of any of the individual receiver branches.

CSI reference signal received power (CSI-RSRP), is defined as the linear average over the power contributions (in [W]) of the resource elements of the antenna port(s) that carry CSI reference signals configured for RSRP measurements within the considered measurement frequency bandwidth in the configured CSI-RS occasions. For CSI-RSRP determination CSI reference signals transmitted on antenna port 3000 according to TS 38.211 3GPP standard specification may be used. If CSI-RSRP is used for L1-RSRP, CSI reference signals transmitted on antenna ports 3000, 3001 can be used for CSI-RSRP determination.

For intra-frequency CSI-RSRP measurements, if the measurement gap is not configured, UE is not expected to measure the CSI-RS resource(s) outside of the active downlink bandwidth part. For frequency range 1, the reference point for the CSI-RSRP may be the antenna connector of the UE. For frequency range 2, CSI-RSRP may be measured based on the combined signal from antenna elements corresponding to a given receiver branch. For frequency range 1 and 2, if receiver diversity is in use by the UE, the reported CSI-RSRP value may not be lower than the corresponding CSI-RSRP of any of the individual receiver branches.

Secondary synchronization signal reference signal received quality (SS-RSRQ) is defined as the ratio of N×SS-RSRP/NR carrier received signal strength indicator (RSSI), where N is the number of resource blocks in the NR carrier RSSI measurement bandwidth. The measurements in the numerator and denominator may be made over the same set of resource blocks. NR carrier RSSI, comprises the linear average of the total received power (in [W]) observed only in certain OFDM symbols of measurement time resource(s), in the measurement bandwidth, over N number of resource blocks from all sources, including co-channel serving and non-serving cells, adjacent channel interference, thermal noise etc.

For cell selection, according to TS 38.211 3GPP standard specification, the measurement time resources(s) for NR Carrier RSSI are not constrained. Otherwise, the measurement time resource(s) for NR Carrier RSSI are confined within SMTC window duration. If indicated by higher-layers, if measurement gap is not used, the NR Carrier RSSI is measured in slots within the SMTC window duration that are indicated by the higher layer parameter measurementSlots and in OFDM symbols given by table in TS 38.215 3GPP standard specification and, if measurement gap is used, the NR Carrier RSSI is measured in slots within the SMTC window duration that are indicated by the higher layer parameter measurementSlots and in OFDM symbols given by table in TS 38.215 3GPP standard specification that are overlapped with the measurement gap, which is defined in TS 38.133 3GPP standard specification.

For intra-frequency measurements, NR Carrier RSSI is measured with timing reference corresponding to the serving cell in the frequency layer.

For inter-frequency measurements, NR Carrier RSSI is measured with timing reference corresponding to any cell in the target frequency layer.

Otherwise not indicated by higher-layers, if measurement gap is not used, NR carrier RSSI is measured from OFDM symbols within SMTC window duration and, if measurement gap is used, NR carrier RSSI is measured from OFDM symbols corresponding to overlapped time span between SMTC window duration and the measurement gap. If higher-layers indicate certain SSBs for performing SS-RSRQ measurements, then SS-RSRP is measured only from the indicated set of SSBs.

For frequency range 1, the reference point for the SS-RSRQ may be the antenna connector of the UE. For frequency range 2, NR carrier RSSI may be measured based on the combined signal from antenna elements corresponding to a given receiver branch, where the combining for NR Carrier RSSI may be the same as the one used for SS-RSRP measurements. For frequency range 1 and 2, if receiver diversity is in use by the UE, the reported SS-RSRQ value may not be lower than the corresponding SS-RSRQ of any of the individual receiver branches.

CSI reference signal received quality (CSI-RSRQ) is defined as the ratio of N×CSI-RSRP to CSI-RSSI, where N is the number of resource blocks in the CSI-RSSI measurement bandwidth. The measurements in the numerator and denominator may be made over the same set of resource blocks. CSI received signal strength indicator (CSI-RSSI), comprises the linear average of the total received power (in [W]) observed only in OFDM symbols of measurement time resource(s), in the measurement bandwidth, over N number of resource blocks from all sources, including co-channel serving and non-serving cells, adjacent channel interference, thermal noise etc. The measurement time resource(s) for CSI-RSSI corresponds to OFDM symbols containing configured CSI-RS occasions.

For CSI-RSRQ determination CSI reference signals transmitted on antenna port 3000 according to TS 38.211 3GPP standard specification may be used. For intra-frequency CSI-RSRQ measurements, if the measurement gap is not configured, UE is not expected to measure the CSI-RS resource(s) outside of the active downlink bandwidth part. For frequency range 1, the reference point for the CSI-RSRQ may be the antenna connector of the UE. For frequency range 2, CSI-RSSI may be measured based on the combined signal from antenna elements corresponding to a given receiver branch, where the combining for CSI-RSSI may be the same as the one used for CSI-RSRP measurements. For frequency range 1 and 2, if receiver diversity is in use by the UE, the reported CSI-RSRQ value may not be lower than the corresponding CSI-RSRQ of any of the individual receiver branches.

SS signal-to-noise and interference ratio (SS-SINR) is defined as the linear average over the power contribution (in [W]) of the resource elements carrying secondary synchronisation signals divided by the linear average of the noise and interference power contribution (in [W]). If SS-SINR is used for L1-SINR reporting with dedicated interference measurement resources, the interference and noise is measured over resource(s) indicated by higher layers as described in TS 38.214 3GPP standard specification. Otherwise, the interference and noise are measured over the resource elements carrying secondary synchronisation signals within the same frequency bandwidth.

The measurement time resource(s) for SS-SINR are confined within SMTC window duration. If SS-SINR is used for L1-SINR as configured by reporting configurations defined in TS 38.214 3GPP standard specification, the measurement time resources(s) restriction by SMTC window duration is not applicable. For SS-SINR determination demodulation reference signals for PBCH in addition to secondary synchronization signals may be used. If SS-SINR is not used for L1-SINR and higher-layers indicate certain SSBs for performing SS-SINR measurements, then SS-SINR is measured only from the indicated set of SSBs. For frequency range 1, the reference point for the SS-SINR may be the antenna connector of the UE. For frequency range 2, SS-SINR may be measured based on the combined signal from antenna elements corresponding to a given receiver branch. For frequency range 1 and 2, if receiver diversity is in use by the UE, the reported SS-SINR value may not be lower than the corresponding SS-SINR of any of the individual receiver branches.

CSI signal-to-noise and interference ratio (CSI-SINR) is defined as the linear average over the power contribution (in [W]) of the resource elements carrying CSI reference signals divided by the linear average of the noise and interference power contribution (in [W]). If CSI-SINR is used for L1-SINR reporting with dedicated interference measurement resources, the interference and noise is measured over resource(s) indicated by higher layers as described in TS 38.214 3GPP standard specification. Otherwise, the interference and noise are measured over the resource elements carrying CSI reference signals within the same frequency bandwidth.

For CSI-SINR determination CSI reference signals transmitted on antenna port 3000 according to TS 38.211 3GPP standard specification may be used. If CSI-SINR is used for L1-SINR, CSI reference signals transmitted on antenna ports 3000, 3001 can be used for CSI-SINR determination. For intra-frequency CSI-SINR measurements not used for L1-SINR reporting, if the measurement gap is not configured, UE is not expected to measure the CSI-RS resource(s) outside of the active downlink bandwidth part. For frequency range 1, the reference point for the CSI-SINR may be the antenna connector of the UE. For frequency range 2, CSI-SINR may be measured based on the combined signal from antenna elements corresponding to a given receiver branch. For frequency range 1 and 2, if receiver diversity is in use by the UE, the reported CSI-SINR value may not be lower than the corresponding CSI-SINR of any of the individual receiver branches.

For L1-RSRP computation: (1) the UE may be configured with CSI-RS resources, SSB resources or both CSI-RS and SSB resources, when resource-wise quasi co-located with “type C” and “typeD” when applicable; and (2) the UE may be configured with CSI-RS resource setting up to 16 CSI-RS resource sets having up to 64 resources within each set. The total number of different CSI-RS resources over all resource sets is no more than 128.

For L1-RSRP reporting, if the higher layer parameter nrofReportedRS in CSI-ReportConfig is configured to be one, the reported L1-RSRP value is defined by a 7-bit value in the range [−140, −44] dBm with 1 dB step size, if the higher layer parameter nrofReportedRS is configured to be larger than one, or if the higher layer parameter groupBasedBeamReporting is configured as “enabled,” or if the higher layer parameter groupBasedBeamReporting-r17 is configured, the UE may use differential L1-RSRP based reporting, where the largest measured value of L1-RSRP is quantized to a 7-bit value in the range [−140, −44] dBm with 1 dB step size, and the differential L1-RSRP is quantized to a 4-bit value. The differential L1-RSRP value is computed with 2 dB step size with a reference to the largest measured L1-RSRP value which is part of the same L1-RSRP reporting instance. The mapping between the reported L1-RSRP value and the measured quantity is described in 3GPP standard specification.

When the higher layer parameter groupBasedBeamReporting-r17 in CSI-ReportConfig is configured, the UE may indicate the CSI resource set associated with the largest measured value of L1-RSRP, and for each group, CRI or SSBRI of the indicated CSI resource set is present first.

If the higher layer parameter timeRestrictionForChannelMeasurements in CSI-ReportConfig is set to “notConfigured,” the UE may derive the channel measurements for computing L1-RSRP value reported in uplink slot n based on only the SSB or NZP CSI-RS, no later than the CSI reference resource, (defined in 3GPP standard specification) associated with the CSI resource setting.

If the higher layer parameter timeRestrictionForChannelMeasurements in CSI-ReportConfig is set to “Configured,” the UE may derive the channel measurements for computing L1-RSRP reported in uplink slot n based on only the most recent, no later than the CSI reference resource, occasion of SSB or NZP CSI-RS (defined in 3GPP standard specification) associated with the CSI resource setting.

When the UE is configured with SSB-MTC-AddtionalPCI, a CSI-SSB-ResourceSet configured for L1-RSRP reporting includes one set of SSB indices and one set of PCI indices, where each SSB index is associated with a PCI index.

When the UE is configured with a CSI-ReportConfig with the higher layer parameter reportQuantity set to “cri-RSRP-Capability[Set] Index” or “ssb-Index-RSRP-Capability[Set] Index” an index of UE capability value set, indicating the maximum supported number of sounding reference signal (SRS) antenna ports, is reported along with the pair of SSBRI/CRI and L1-RSRP.

For L1-SINR computation and channel measurement, the UE may be configured with NZP CSI-RS resources and/or SSB resources, for interference measurement, the UE may be configured with NZP CSI-RS or CSI-IM resources. For channel measurement, the UE may be configured with CSI-RS resource setting with up to 16 resource sets, with a total of up to 64 CSI-RS resources or up to 64 SSB resources.

For L1-SINR reporting, if the higher layer parameter nrofReportedRS in CSI-ReportConfig is configured to be one, the reported L1-SINR value is defined by a 7-bit value in the range [−23, 40] dB with 0.5 dB step size, and if the higher layer parameter nrofReportedRS is configured to be larger than one, or if the higher layer parameter groupBasedBeamReporting is configured as “enabled,” the UE may use differential L1-SINR based reporting, where the largest measured value of L1-SINR is quantized to a 7-bit value in the range [−23, 40] dB with 0.5 dB step size, and the differential L1-SINR is quantized to a 4-bit value. The differential L1-SINR is computed with 1 dB step size with a reference to the largest measured L1-SINR value which is part of the same L1-SINR reporting instance. When NZP CSI-RS is configured for channel measurement and/or interference measurement, the reported L1-SINR values may not be compensated by the power offset(s) given by higher layer parameter powerControlOffsetSS or powerControlOffset.

When one or two resource settings are configured for L1-SINR measurement: (1) if the higher layer parameter timeRestrictionForChannelMeasurements in CSI-ReportConfig is set to “notConfigured,” the UE may derive the channel measurements for computing L1-SINR reported in uplink slot n based on only the SSB or NZP CSI-RS, no later than the CSI reference resource, (defined in 3GPP standard specification) associated with the CSI resource setting; (2) if the higher layer parameter timeRestrictionForChannelMeasurements in CSI-ReportConfig is set to “configured,” the UE may derive the channel measurements for computing L1-SINR reported in uplink slot n based on only the most recent, no later than the CSI reference resource, occasion of SSB or NZP CSI-RS (defined in 3GPP standard specification) associated with the CSI resource setting; (3) if the higher layer parameter timeRestrictionForlnterferenceMeasurements in CSI-ReportConfig is set to “notConfigured,” the UE may derive the interference measurements for computing L1-SINR reported in uplink slot n based on only the CSI-IM or NZP CSI-RS for interference measurement (defined in 3GPP standard specification) or NZP CSI-RS for channel and interference measurement no later than the CSI reference resource associated with the CSI resource setting; and (4) if the higher layer parameter timeRestrictionForlnterferenceMeasurements in CSI-ReportConfig is set to “configured,” the UE may derive the interference measurements for computing the L1-SINR reported in uplink slot n based on the most recent, no later than the CSI reference resource, occasion of CSI-IM or NZP CSI-RS for interference measurement (defined in 3GPP standard specification) or NZP CSI-RS for channel and interference measurement associated with the CSI resource setting.

When the UE is configured a CSI-ReportConfig with the higher layer parameter reportQuantity set to “cri-SINR-Capability[Set] Index” or “ssb-Index-SINR-Capability[Set] Index” an index of UE capability value, indicating the maximum supported number of SRS antenna ports, is reported along with the pair of SSBRI/CRI and L1-SINR.

An RRC_CONNECTED UE may derive cell measurement results by measuring one or multiple beams associated per cell as configured by the network, as described in 3GPP standard specification. For all cell measurement results, except for RSSI, and CLI measurement results in RRC_CONNECTED, the UE applies the layer 3 filtering as specified in 3GPP standard specification, before using the measured results for evaluation of reporting criteria, measurement reporting or the criteria to trigger conditional reconfiguration execution.

For layer 3 filtering, the UE may, for each cell measurement quantity, each beam measurement quantity, each sidelink measurement quantity, for each CLI measurement quantity that the UE performs measurements according to 3GPP standard specification, and for each candidate L2 U2N Relay UE measurement quantity according to 3GPP standard specification, filter the measured result, before using for evaluation of reporting criteria or for measurement reporting, by the following formula: Fₙ=(1−a)*Fₙ₋₁+a*Mₙ where: Mₙ is the latest received measurement result from the physical layer; Fₙ is the updated filtered measurement result, that is used for evaluation of reporting criteria or for measurement reporting; Fₙ₋₁ is the old filtered measurement result, where F₀ is set to M₁ when the first measurement result from the physical layer is received; and for MeasObjectNR, a=1/2^{(ki/4)}, where kᵢ is the filterCoefficient for the corresponding measurement quantity of the i-th QuantityConfigNR in quantityConfigNR-List, and i is indicated by quantityConfigIndex in MeasObjectNR; for other measurements, a=1/2^{(k/4)}, where k is the filterCoefficient for the corresponding measurement quantity received by the quantityConfig; for UTRA-FDD, a=1/2^{(k/4)} where k is the filterCoefficient for the corresponding measurement quantity received by quantityConfigUTRA-FDD in the QuantityConfig.

The UE may adapt the filter such that the time characteristics of the filter are preserved at different input rates, observing that the filterCoefficient k assumes a sample rate equal to X ms; The value of X is equivalent to one intra-frequency L1 measurement period as defined in TS 38.133 3GPP standard specification assuming non-discontinuous reception (non-DRX) operation, and depends on frequency range.

Present networks have limited capability to adapt an operation state in one or more of time/frequency/spatial/power domains. For example, in NR, there are transmissions or receptions by a serving gNB that are always expected by UEs, such as transmissions of SSBs or system information or of CSI-RS indicated by higher layers, or receptions of physical random access channel (PRACH) or SRS indicated by higher layers. Reconfiguration of a NW operation state involves higher layer signaling by a SIB or by UE-specific RRC. That is a slow process and requires substantial signaling overhead, particularly for UE-specific RRC signaling.

For example, it is currently not practical or possible for a network in typical deployments to enter an energy saving state where the network does not transmit or receive due to low traffic as, in order to obtain material energy savings, the network needs to suspend transmissions or receptions for several tens of milliseconds and preferably for even longer time periods. A similar inability exists for suspending transmission or receptions for shorter time periods as a serving gNB may need to transmit SSBs every 5 msec and, in TDD systems with UL-DL configurations having few UL symbols in a period, the serving gNB may need to receive PRACH or SRS in most UL symbols in a period.

Due to the above reasons, adaptation of a NW operation state is typically over long time periods, such as for off-peak hours when an amount of served traffic is small and for peak hours when an amount of served traffic is large. Therefore, a capability of a gNB to improve service by fast adaptation of a NW operation state to the traffic types and load, or to save energy by switching to a state that requires less energy consumption when an impact on service quality may be limited or none, is currently limited as there are no procedures for a serving gNB to perform fast adaptation of a NW operation state, with small signaling overhead, while simultaneously informing all UEs.

It is also beneficial to support a gradual transition of NW operation states between a maximum state where the NW operates at its maximum capability in one or more of a time/frequency/spatial/power domain and a minimum state where the NW operates at its minimum capability, or the NW enters a sleep mode. That may allow continuation of service while the NW transitions from a state with larger utilization of time/frequency/spatial/power resources to a state with lower utilization of such resources and the reverse as UEs can obtain time/frequency synchronization and automatic gain controller (AGC) alignments, perform measurements and provide CSI reports or transmit SRS prior to scheduling of physical downlink shared channel (PDSCH) receptions or physical uplink shared channel (PUSCH) transmissions.

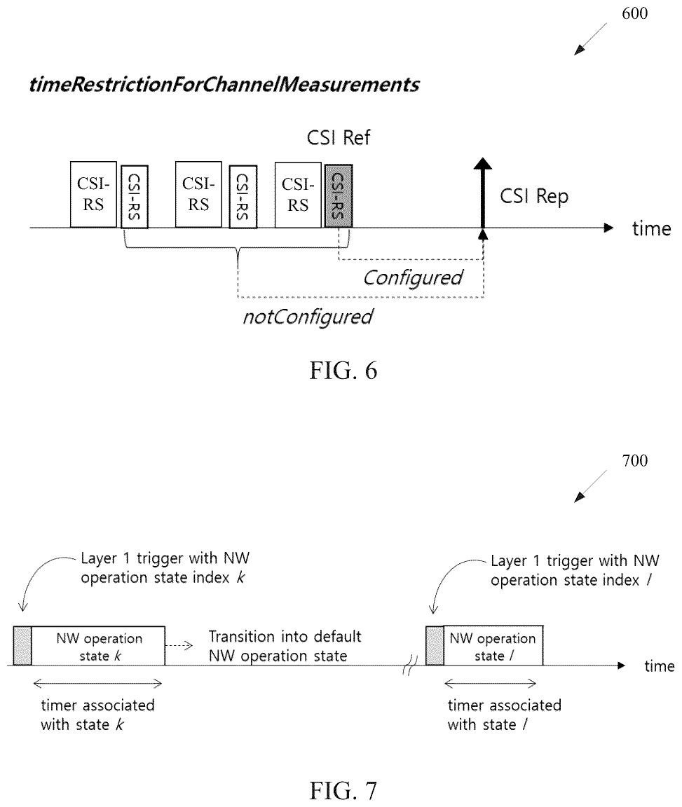

FIG. 6 illustrates an example of CSI measurement 600 according to embodiments of the present disclosure. An embodiment of the CSI measurement 600 shown in FIG. 6 is for illustration only.

For L1-RSRP, the measurement follows CSI resource configuration, not restricted by SMTC. The CSI resource configuration can include nzp-CSI-RS-ResourceSetList and csi-SSB-ResourceSetList for L1 RSRP measurement. The NZP CSI-RS can be used in addition to SSB, if indicated along with CSI-RS power offset relative to SS, i.e., powerControlOffsetSS in NZP-CSI-RS-Resource configuration. Per timeRestrictionForChannelMeasurements configuration, if provided, the measurement can be restricted to the most recent occasion of SSB or NZP CSI-RS, no later than the CSI reference resource.

For a system with NW operation state adaptation, the NW may skip transmitting SSB and/or NZP CSI-RS or transmit SSB and/or NZP CSI-RS with a reduced energy per resource element (EPRE) and/or with different beam characteristics by applying different spatial filter for the purpose of network energy saving.

For L1 RSRP/RSRQ/SINR, the UE can combine multiple measurements no later than the CSI reference resource, if timeRestrictionForChannelMeasurements is not provided. If the NW skips transmitting SSB and/or NZP CSI-RS or the NW transmits SSB and/or NZP CSI-RS with a reduced EPRE, there is a need for indicating to a UE the presence of SSB and/or NZP CSI-RS and the EPRE offset for the transmission of SSB and/or NZP CSI-RS in a given NW operation state so that the UE can correctly combine the multiple measurements across different NW operation states.

For a CSI report by a UE, the NW may discontinue its UL reception for some NW operation states for the purpose of network energy saving. Therefore, there is another need for indicating the UE whether the CSI report is allowed in a certain NW operation state and yet another need for defining UE behavior if providing CSI reports is not allowed in a certain NW operation state.

If SSB and/or NZP CSI-RS is not transmitted in a certain NW operation state or transmitted with reduced EPRE, there is another need to indicate to a UE, or for the UE to determine, the presence of SSB and/or NZP CSI-RS, the EPRE for transmitting SSB and/or NZP CSI-RS, and/or parameters related to L3 filtering for the UE to compensate the EPRE difference in L1 measurements across different measurement occasions.

The present disclosure relates to a communication system. The present disclosure relates to defining functionalities and procedures for adaptation of NW operation states. The present disclosure also relates to indicating a UE the presence of SSB and/or NZP CSI-RS and the EPRE offset for the transmission of SSB and/or NZP CSI-RS in a given NW operation state. The present disclosure further relates to indicating the UE whether the CSI report is allowed in a certain NW operation state and the UE behavior if sending CSI report is not allowed in a certain NW operation state. The present disclosure additionally relates to indicating the UE the presence of SSB and/or NZP CSI-RS, the EPRE and/or transmission configuration indicator (TCI) states for transmitting SSB and/or NZP CSI-RS, and/or parameters for L3 filtering for the UE to compensate the EPRE/TCI state difference in L1 measurement across different measurement occasions falling in different NW operation states.

Embodiments of the disclosure for enabling a serving gNB to inform UEs of an adaptation to a NW operation state, such as for example for supporting network energy savings, are summarized in the following and are fully elaborated further below.

In one embodiment, method and apparatus are provided for indicating NW operation states and parameters related to power offset for transmission of SSBs and/or NZP CSI-RS for CSI calculation.

In one embodiment, method and apparatus are provided for indicating allowance of CSI reports in a slot falling in a certain NW operation state and the UE behavior when providing CSI reports is not allowed in a certain NW operation state.

In one embodiment, method and apparatus are provided for indicating NW operation states and parameters related to presence of SSB and/or CSI-RS transmissions, SSB and/or CSI-RS transmission power and L3 filtering, and method and apparatus for a UE to perform L3 filtering of L1 measurements obtained across different NW operation states.

For brevity, a DCI format that provides indication of NW operation states is referred to as DCI format 2_8 in the present disclosure.

The general principle for adaptation of NW operation states by physical layer signaling includes a serving gNB indicating to a UE a set of NW operation states by higher layer signaling, such as by a SIB or UE-specific RRC signaling, and transmitting a PDCCH that provides a DCI format (e.g., DCI format 2_8 or a new DCI format) indicating an index to the set of NW operation states for the UE to determine an update of NW operation states.

FIG. 7 illustrates an example of timing diagram of NW operation state transition 700 according to embodiments of the present disclosure. An embodiment of the timing diagram of NW operation state transition 700 shown in FIG. 7 is for illustration only.

A NW transitions from a first NW operation state, denoted as state k, to a second NW operation state, denoted as state l. For example, each NW operation state may represent a light/mid/heavy NW energy saving (ES) mode by the NW using different ES methods and parameter configurations. A serving gNB can provide to a UE parameters for each index of a NW operation state and corresponding values for the parameters in a SIB or via UE-specific higher layer signaling. A UE can then identify a NW operation state based on an indicated value of the NW operation state index.

In one embodiment, the NW indicates to a UE a set of multiple NW operation states that can include a default state. A NW operation state can include parameters associated with transmission/reception by the network in one or more of a power, spatial, time, or frequency domain and corresponding IEs.

For example, in a power domain, a first NW operation state can be associated with a first value of parameter ss-PBCH-BlockPower providing an average energy per resource element (EPRE) with secondary synchronization signals (SSS) in dBm, and a second NW operation state can be associated with a second value of a parameter ss-PBCH-BlockPower. For example, first and second NW operation states can be respectively associated with first and second values of parameter powerControlOffsetSS that provides a power offset (in dB) of non-zero power (NZP) CSI-RS RE to SSS RE. For example, first and second NW operation states can be respectively associated with first and second values of parameter powerControlOffset that provides a power offset (in dB) of PDSCH RE to NZP CSI-RS RE.

For example, in a frequency domain, the first and second NW operation states can be respectively associated with the first and second values of a parameter locationAndBandwidth that indicates a frequency domain location and a bandwidth for receptions or transmissions by UEs. For example, first and second NW operation states can be respectively associated with first and second values of a list of serving cells for active transmission and reception.

For example, in a spatial domain, the first and second NW operation states can be respectively associated with the first and second values of a parameter maxMIMO-Layers that indicates a maximum number of MIMO layers to be used for PDSCH receptions by a UE in the associated active DL BWP, or with first and second values of a parameter nrOfAntennaPorts that indicates a number of antenna ports to be used for codebook determination for PDSCH receptions, or with first and second values of a parameter activeCoresetPoolIndex that coresetPoolIndex values for PDCCH transmissions in corresponding CORESETs and UEs can skip PDCCH receptions in a CORESET with coresetPoolIndex value that is not indicated by activeCoresetPoolIndex. For example, first and second NW operation states can be respectively associated with first and second values of an antenna port subset that indicates a list of active antenna ports for CSI calculation and other associated parameters such as codebook subset restriction, rank restriction, the logical antenna size in two-dimension, number of antenna ports, and a list of CSI-RS resources, etc.

For example, in a time domain, the first and second NW operation states can be respectively associated with the first and second values of a parameter ssb-PeriodicityServingCell that indicates a transmission periodicity in milliseconds for SSBs, or with first and second values of a parameter ssb-PositionsInBurst that indicates time domain positions of SSBs in a SSB transmission burst, or with first and second values of a parameter groupPresence that indicates groups of SSBs, such as groups of eight SSBs with consecutive indexes, that are transmitted, or with first and second values of a parameter inOneGroup that indicates the time domain positions of SSBs in a group, such as eight SSBs with consecutive indexes in a group, that are transmitted. For example, first and second NW operation states can be respectively associated with first and second values of a time pattern, e.g., in terms of periodicity, on-duration, start offset, etc., that indicates cell discontinuous transmission (DTX) or cell DRX.

A serving gNB can provide a UE one or more search space sets to monitor PDCCH for detection of a DCI format (e.g., DCI format 2_8 or a new DCI format) that indicates NW operation states as described in the subsequent embodiments of the disclosure. The search space sets can be separate from other search space sets that the serving gNB provides to the UE or some or all search space sets can be common and the UE can monitor PDCCH for the detection of both the DCI format that indicates NW operation states (e.g., DCI format 2_8 or a new DCI format) and for other DCI formats providing information for scheduling PDSCH receptions or PUSCH transmissions or SRS transmissions, or providing other control information for the UE to adjust parameters related to transmissions or receptions.

The search space sets can be common search space (CSS) sets or UE-specific search space (USS) sets. When the search space sets are CSS sets, a serving gNB can indicate the search space sets associated with the DCI format (e.g., DCI format 2_8 or a new DCI format) through higher layer signaling in a SIB or through UE-specific RRC signaling. A UE can monitor PDCCH for detection of DCI format (e.g., DCI format 2_8 or a new DCI format) both in the RRC_CONNECTED state and in the RRC_INACTIVE state according to the corresponding search space sets and DRX operation may not apply for PDCCH receptions that provide the DCI format (e.g., DCI format 2_8 or a new DCI format).

A UE can receive PDCCHs providing the DCI format (e.g., DCI format 2_8 or a new DCI format) in an active DL BWP. Alternatively, a UE can receive PDCCHs providing the DCI format (e.g., DCI format 2_8 or a new DCI format) in an initial DL BWP that was used by all UEs to perform initial access and establish RRC connection with a serving gNB. The latter option enables a single PDCCH transmission with the DCI format (e.g., DCI format 2_8 or a new DCI format) from the serving gNB to all UEs because the initial DL BWP is common to all UEs, while the former option avoids a BWP switching delay because a UE receives PDCCHs providing the DCI format (e.g., DCI format 2_8 or a new DCI format) in the active DL BWP. It is also possible that the serving gNB indicates the DL BWP for PDCCH receptions that provide the DCI format (e.g., DCI format 2_8 or a new DCI format) through higher layer signaling, for example in a SIB.

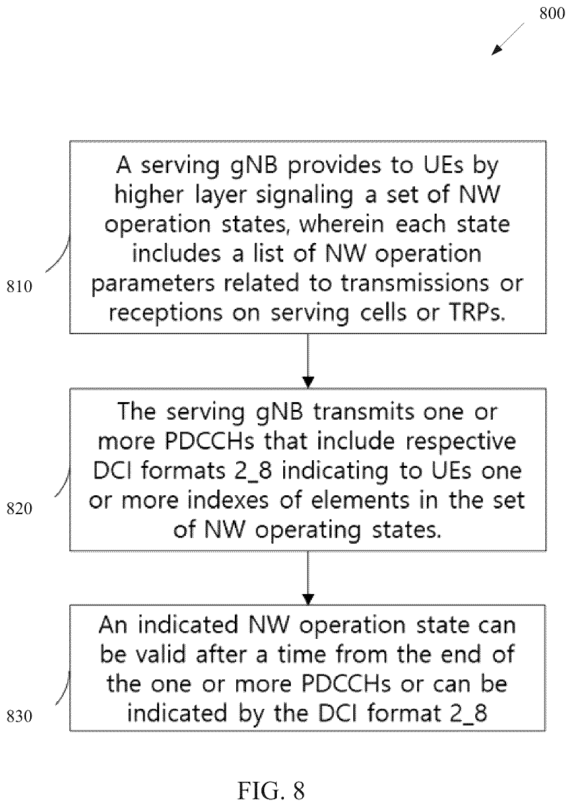

FIG. 8 illustrates a flowchart of NW procedure 800 to indicate and activate NW operation states according to embodiments of the present disclosure. The NW procedure 800 as may be performed by a base station (e.g., 101-103 as illustrated in FIG. 1). An embodiment of the NW procedure 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

A serving gNB provides to UEs by higher layer signaling a set of NW operation states, wherein each state includes a list of NW operation parameters related to transmissions or receptions on serving cells for example in one or more of time, frequency, spatial, or power domains 810. The higher layer signaling can be via a SIB and provided, for example, by ServingCellConfigCommonSIB, or can be UE-specific RRC signaling and provided, for example, by ServingCellConfigCommon. The serving gNB transmits one or more PDCCHs that include respective DCI formats (e.g., DCI format 2_8 or a new DCI format) indicating to UEs one or more indexes of elements in the set of NW operating states 820. An indicated NW operation state can be valid after a time from the end of the one or more PDCCHs that can be predefined in the specifications of the system operation or can be indicated by the DCI format (e.g., DCI format 2_8 or a new DCI format) 830.

The serving gNB can also provide to UEs by higher layer signaling a set of one or more timer values. The timer values can be in absolute time, such as milliseconds, or in a number of symbols, slots, or subframes based on a numerology/SCS of the active DL BWP or of a reference DL BWP, such as the initial DL BWP, on the primary cell or based on a reference numerology/SCS. If the set includes more than one timer values, the DCI format (e.g., DCI format 2_8 or a new DCI format) can also indicate a timer value. After the timer expires before the serving gNB transmits another PDCCH with the DCI format (e.g., DCI format 2_8 or a new DCI format) to indicate another NW operation state, the NW operation state becomes a default one that can be provided by higher layer signaling, or becomes a predetermined state from the set of NW operation states such as the first state or the last state.

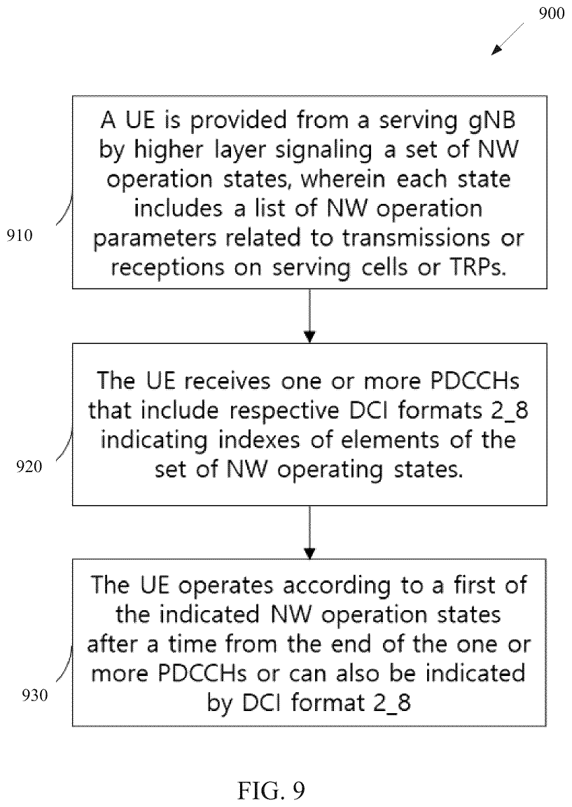

FIG. 9 illustrates a flowchart of UE procedure 900 to receive and activate NW operation states according to embodiments of the present disclosure. The UE procedure 900 as may be performed by a UE (e.g., 111-116 as illustrated in FIG. 1). An embodiment of the UE procedure 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

A UE is provided from a serving gNB by higher layer signaling a set of NW operation states, wherein each state includes a list of NW operation parameters related to transmissions or receptions on serving cells or TRPs for example in one or more of time, frequency, spatial, or power domains 910. The higher layer signaling can be a SIB and be provided, for example, by ServingCellConfigCommonSIB, or can be UE-specific RRC signaling and be provided, for example, by ServingCellConfigCommon. The UE receives one or more PDCCHs that include respective DCI formats (e.g., DCI format 2_8 or a new DCI format) indicating indexes of elements of the set of NW operating states 920. The UE operates according to a first of the indicated NW operation states after a time from the end of the one or more PDCCHs that can be predefined in the specifications of the system operation or can also be indicated by the DCI format (e.g., DCI format 2_8 or a new DCI format) 930.

The UE can also be provided by higher layer signaling from the serving gNB a set of one or more timer values that can be in absolute time, such as milliseconds, or in a number of symbols, slots, or subframes based on a numerology/SCS of the active DL BWP or of a reference DL BWP such as the initial DL BWP, on the primary cell, or based on a reference numerology/SCS such as 15 kHz. If the set of timer values includes more than one timer value, the DCI format (e.g., DCI format 2_8 or a new DCI format) can also indicate the timer value. If the UE does not receive another PDCCH with DCI format (e.g., DCI format 2_8 or a new DCI format) that indicates another NW operation state and the timer expires, the UE can assume operation according to a NW operation state that can be a default one that is provided by higher layer signaling, or can be a predetermined state from the set of NW operation states such as the first state or the last state.

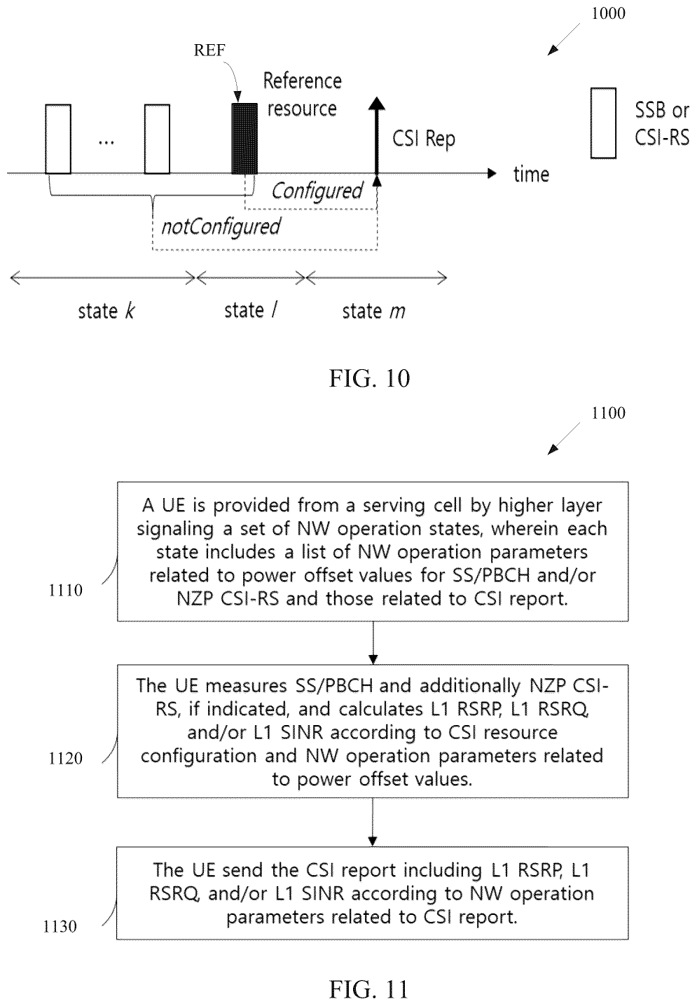

FIG. 10 illustrates an example of measurement enhancement with NW operation states 1000 according to embodiments of the present disclosure. An embodiment of the measurement enhancement with NW operation states 1000 shown in FIG. 10 is for illustration only.

FIG. 11 illustrates a flowchart of UE procedure 1100 for CSI measurement enhancement with NW operation states according to embodiments of the present disclosure. The UE procedure 1100 as may be performed by a UE (e.g., 111-116 as illustrated in FIG. 1). An embodiment of the UE procedure 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

FIG. 11 illustrates an example procedure for a NW to provide and for a UE to obtain an indication on NW operation parameters related to CSI measurements and reports, and for the UE to perform measurements and provide reports according to the disclosure. The NW switches its operation state from state k to state l and then to state m. As previously described, the UE is provided from a serving gNB by higher layer signaling a set of NW operation states and the serving gNB can indicate to the UE a NW operation state transition via DCI, MAC CE, UE-specific RRC or a SIB.

A UE receives from a serving cell by higher layer signaling a set of NW operation states and a list of associated NW operation parameters related to L1 measurements, such as power offset values for SSBs, NZP CSI-RS, and/or PDSCH and parameters related to CSI reports 1110. For a system without NW operation state adaptation, the UE may assume that a EPRE is constant across the bandwidth and over SSS included in different SSBs for the purpose of SS-RSRP, SS-RSRQ and SS-SINR measurements. For a system with NW operation state adaptation, the UE may be indicated different EPRE values for different BWPs of a serving cell and/or different EPRE values for different SSBs transmitted by a serving gNB in different NW operation states. The SSB EPRE can be derived from ss-PBCH-BlockPower provided by higher layers for a corresponding NW operation state. The NW can apply different EPRE values for the transmission of SSBs in different NW operation states, for example for the purpose of NW energy savings. In such case, the UE is indicated a set of EPRE values for the transmission of SSBs associated with the different NW operation states.

In one example, a set of ss-PBCH-BlockPower values are indicated for a set of NW operation states for a serving cell as an absolute EPRE value in dBm that the serving cell uses for the transmission of SSBs. The values can be separately provided for each serving cell for the UE or can be common for all serving cells or for groups of serving cells. For example, the UE is indicated by a serving gNB for a serving cell a set of ss-PBCH-BlockPower values, i.e., a first value corresponding to a ss-PBCH-BlockPower_1 value for a first NW operation state, which can be a default state, a second value corresponding to ss-PBCH-BlockPower_2 value for a second NW operation state, and so on.

In another example, an absolute EPRE value in dBm that the NW uses for transmission of SSBs on a serving cell is indicated for a first NW operation state, or a default NW operation state, and power offset values in dBm are indicated for the subsequently indicated NW operation states. The values can be separately provided for each serving cell for the UE or can be common for all serving cells or for groups of serving cells. For example, the UE is indicated by a gNB for a serving cell a ss-PBCH-BlockPower value for the first NW operation state or the default NW operation state, a power offset to ss-PBCH-BlockPower by a ss-PBCH-BlockPowerOffset1 value for the second NW operation state, a power offset to ss-PBCH-BlockPower by a ss-PBCH-BlockPowerOffset2 value for the third NW operation state, and so on.

In another example, the NW may or may not transmit SSBs in a NW operation state on a serving cell. Whether or not the NW/gNB transmits SSBs for a given NW operation state on the serving cell can be indicated to the UE by the gNB using a field of one-bit for the NW operation state. For example, the UE is indicated by the gNB for the serving cell a ss-PBCH-BlockPower value for the first NW operation state or the default NW operation state and a bitmap of size N−1 bits, where N is the total number of indicated NW operation states, where each bit in the bitmap indicates whether or not SSBs are transmitted on the serving cell during a corresponding NW operation state. If the UE is indicated by the serving gNB that the SSB is transmitted during a NW operation state k on the serving cell, the UE may assume that the same power level indicated for the first NW operation state, or the default NW operation state is used for SSB transmission for NW operation state k.

Alternatively, the UE can be separately indicated the EPRE for SSB transmissions on the serving cell for each NW operation state where SSB is transmitted, e.g., by higher layer signalling as previously described, at least if the EPRE value used during the NW operation state is different from the value, ss-PBCH-BlockPower, indicated for the first NW operation state or the default NW operation state.

For L1-RSRP calculation, if indicated by higher layers, a UE may use CSI-RS in addition to SSS. For a system without NW operation state adaptation, the UE may assume that a downlink EPRE of a port of CSI-RS resource configuration is constant across the configured downlink bandwidth and constant across all configured OFDM symbols for the purpose of CSI-RSRP, CSI-RSRQ and CSI-SINR measurements. For a system with NW operation state adaptation, the UE may be signaled on different EPRE values for CSI-RS for different NW operation states for a serving cell.

The EPRE values for a CSI-RS transmission may also be different for different DL BWPs within a downlink cell bandwidth of the serving cell and/or for different OFDM symbols or slots in different NW operation states. The CSI-RS EPRE can be derived from the SSB transmit power provided by a ss-PBCH-BlockPower value and a CSI-RS power offset provided by a powerControlOffsetSS value. If the UE is indicated more than one NW operation states, the NW can apply different EPRE values for the transmission of SSBs and/or CSI-RS on a serving cell across different NW operation states. In such a case, the UE is indicated a set of powerControlOffsetSS values corresponding to CSI-RS power offsets associated with the different NW operation states.

In one example, a UE is indicated a set of powerControlOffsetSS values for a set of indicated NW operation states. The values can be separately provided for each serving cell for the UE or can be common for all serving cells or for groups of serving cells. Each value indicates an offset of EPRE in dBm with respect to a ss-PBCH-BlockPower value that is indicated for a first NW operation state or a default NW operation state. For example, the CSI-RS EPRE in NW operation state k can be derived from a ss-PBCH-BlockPower value and a powerControlOffsetSS_k value that is the CSI-RS power offset indicated for NW operation state k.

In another example, a UE is indicated a set of powerControlOffsetSS values for a set of indicated NW operation state. The values can be separately provided for each serving cell for the UE or can be common for all serving cells or for groups of serving cells. Each value indicates an offset of EPRE in dBm with respect to a ss-PBCH-BlockPower value indicated for a corresponding NW operation state. For example, the downlink CSI-RS EPRE in NW operation state k can be derived from a ss-PBCH-BlockPower_k value for the SSB transmission power for NW operation state k and a powerControlOffsetSS_k value that is the CSI-RS power offset indicated for NW operation state k.

In another example, a UE is indicated a set of powerControlOffsetSS values for a set of indicated NW operation states. The values can be separately provided for each serving cell for the UE or can be common for all serving cells or for groups of serving cells. A first value, provided by powerControlOffsetSS_1, is an offset of EPRE in dBm with respect to a ss-PBCH-BlockPower value indicated for the first NW operation state or the default NW operation state and the subsequent values, powerControlOffsetSS_2, . . . , powerControlOffsetSS_N, where N is the total number of indicated NW operation states, are offsets of EPRE in dBm with respect to powerControlOffsetSS_1. The indicated offset can be zero or a negative value. For example, a CSI-RS EPRE in NW operation state k for k=2, . . . , N can be derived from a ss-PBCH-BlockPower value, that is the SSB transmission power for the first NW operation state or default NW operation state, a powerControlOffsetSS_1 value that is the CSI-RS power offset value for the first NW operation state or default NW operation state, and a powerControlOffsetSS_k value that is the CSI-RS power offset value for the NW operation state k with respect to powerControlOffsetSS_1.

In another example, the NW indicates to a UE whether the UE can use CSI-RS, in addition to SS, for L1 measurements. If the UE is indicated to not to use CSI-RS for L1 measurements on a serving cell for a certain NW operation state, the serving gNB may not transmit CSI-RS on the serving cell during that NW operation state. For example, the UE is indicated by a gNB for a serving cell a bitmap of size N, where N is the total number of indicated NW operation states for the serving cell. Each bit in the bitmap indicates whether the UE can use CSI-RS in addition to SS for L1 measurements while the serving cell is in a NW operation state corresponding to the bit position in the bitmap. If the UE is indicated by the serving gNB to use CSI-RS in addition to SS for L1 measurements on the serving cell, the UE can assume that a single powerControlOffsetSS value applies to all NW operation states. Alternatively, the UE can be separately indicated the offset values for each NW operation state as previously described in the disclosure.

For L1 measurement, a UE may be provided indexes for SSBs, CSI-RS resources, or both SSBs and CSI-RS resources. The UE then measures SSBs and/or CSI-RS according to the provided indexes for SSB and/or CSI-RS resources and calculates L1-RSRP, L1-RSRQ, and/or L1-SINR according to a CSI report configuration 1120. In calculating L1-RSRP, L1-RSRQ, and/or L1-SINR, the UE utilizes the indicated set of ss-PBCH-BlockPower values and powerControlOffsetSS values to determine the EPRE used by the NW for the transmission of SSBs and/or CSI-RS in different NW operation states. If timeRestrictionForChannelMeasurements in CSI-ReportConfig is set to “notConfigured,” the UE derives the channel measurements for a CSI report in a slot based on only the SSBs or NZP CSI-RS resources, no later than the CSI reference resource, associated with the CSI resource setting.

In FIG. 10, the rightmost SSBs and/or NZP CSI-RS resources represent the CSI reference resource for the indicated CSI report slot for a UE and the UE can additionally utilizes measurements from the previous SSBs and/or NZP CSI-RS resources no later than the CSI reference resource for the calculation of CSI report for the indicated CSI report slot. For example, the measurements can span over different NW operation states k and l. If the UE is indicated by the serving gNB a set of values for EPRE used for the transmission of SSBs and/or CSI-RS on a serving cell in NW operation state k and l, the UE compensates the EPRE difference in the measurements prior to combining the measurements into a single report for the serving cell. If timeRestrictionForChannelMeasurements in CSI-ReportConfig is set to “Configured,” as described in 3GPP standard specification and possibly adjusted to an independent setting for procedures related to adaptation of NW operation states, the UE derives the channel measurements for a report in a slot based on only the most recent, no later than the CSI reference resource, occasion of SSB or NZP CSI-RS resources associated with the CSI resource setting.

In FIG. 10, the leftmost SSB and/or NZP CSI-RS resource that occurs when the NW operation state l will then be the measurement occasion for the UE to derive the report to provide to the gNB for the serving cell in the following CSI report slot. The UE uses the indicated EPRE values for SSBs and/or CSI-RS resources in NW operation state l according to the embodiments in the disclosure for the calculation of L1-RSRP, L1-RSRQ, and/or L1-SINR.

A UE can be configured to provide periodic or semi-persistent CSI reports by physical uplink control channel (PUCCH) transmissions, or semi-persistent or aperiodic CSI reports by PUSCH transmissions scheduled by DCI formats. The UE can be also indicated by a serving gNB via higher layer signaling a set of NW operation states and whether providing CSI reports is allowed or not for a network operation state 1130. For a periodic or semi-persistent CSI report on PUCCH, the periodicity T_{CSI} (for example, measured in slots for the active UL BWP of PUCCH transmissions) and the slot offset T_{offset} are indicated by reportSlotConfig, and the UE provides the CSI report via PUCCH transmissions in frames with SFN n_{f} and slot number within the frame n_{s,f}^{μ} satisfying (Nₛₗₒₜ^{frame,μ}+n_{f}+n_{s,f}^{μ}−T_{offset})mod T_{CSI}=0, where μ is the SCS configuration of the UL BWP for the PUCCH transmission.

For a semi-persistent CSI report on a PUSCH, the periodicity T_{CSI} (for example, measured in slots for the active UL BWP of PUCCH transmissions) is indicated by reportSlotConfig, and the UE transmits the PUSCH with the CSI report in frames with SFN n_{f} and slot number within the frame n_{s,f}^{μ} satisfying (Nₛₗₒₜ^{frame,μ}(n_{f}−n_{f}^{start})+n_{s,f}^{μ}−n_{s,f}^{start})mod T_{CSI}=0, where n_{f}^{start} and nₛ^{start} are the SFN and slot number within the frame respectively of the initial configured grant PUSCH transmission according to the DCI format activating the PUSCH transmission. The UE derives CSI report slot for periodic, semi-persistent, and/or aperiodic CSI reports according to the above equations.

In FIG. 10, for example, the derived CSI report slot falls in the NW operation state m. The UE then follows an indication from the serving gNB related to CSI report configuration during the NW operation state m. For example, the serving gNB may discontinue receptions, i.e., cell DRX, for some NW operation states for the purpose of energy savings while the serving gNB may continue receptions for some other NW operation states. If the serving gNB indicates that CSI reports are allowed during NW operation state m, the UE provides the CSI report according to the corresponding CSI-ReportConfig. If the serving gNB indicates that CSI report is not allowed during NW operation state m, i.e., cell DRX, the UE skips CSI reports in respective CSI report slot and the UE provides the report in a next earliest slot that falls in a NW operation state allowing CSI reports.

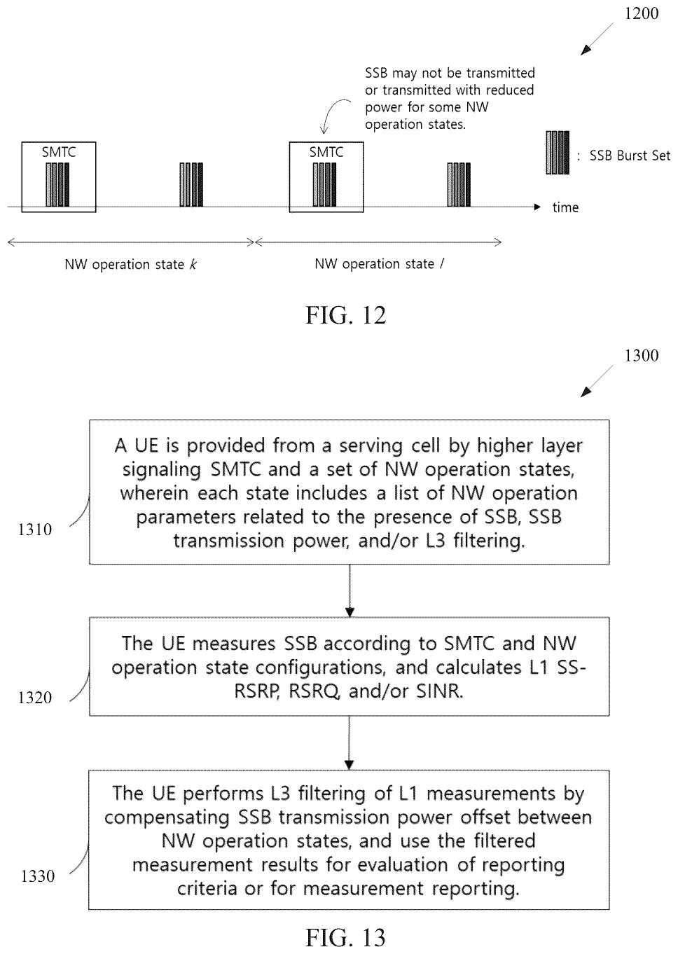

FIG. 12 illustrates an example of measurement enhancement with NW operation states 1200 according to embodiments of the present disclosure. An embodiment of the measurement enhancement with NW operation states 1200 shown in FIG. 12 is for illustration only.

FIG. 13 illustrates a flowchart of UE procedure 1300 for L3 measurement enhancement with NW operation states for SSB-based L1 measurements according to embodiments of the present disclosure. The UE procedure 1300 as may be performed by a UE (e.g., 111-116 as illustrated in FIG. 1). An embodiment of the UE procedure 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

FIG. 13 illustrates an example procedure for a NW to provide and for a UE to obtain an indication on NW operation parameters related to SSB-based L1 measurements and L3 filtering, and for the UE to perform L1 measurements and L3 filtering prior to using filtered measurement results for evaluation of reporting criteria or for measurement reporting, according to the disclosure. In the diagram, the NW changes an operation state from state k to state l and so on. As previously described, a UE is provided from a gNB per serving cell or for all serving cell a set of NW operation states by higher layer signaling and the gNB can indicate to the UE a NW operation state transition for a serving cell via DCI, MAC CE, SIB, or UE-specific RRC signaling.

A UE receives by higher layer signaling from a gNB for a serving cell or a group of serving cells SMTC, a set of NW operation states, and a list of associated NW operation parameters related to the presence of SSB, SSB transmission power, and/or L3 filtering 1310. For L3 filtering, the SSB measurement time resources are confined within the indicated SMTC window duration as illustrated in FIG. 12. For a system without NW operation state adaptation, the UE may assume that the SSB is present during the indicated SMTC window duration and downlink EPRE is constant across the bandwidth and over SSS of different SSBs for the purpose of SS-RSRP, SS-RSRQ and SS-SINR measurements. For a system with NW operation state adaptation, SSB may not be transmitted on a serving cell during the configured SMTC window duration or SSB may be transmitted with reduced power.

To perform L1 SS-RSRP/RSRQ/SINR measurements and to correctly perform L3 filtering, the UE is indicated from the gNB whether SSB transmission on the serving cell is present in a given NW operation state. The presence of SSB can be indicated using a bitmap of size N, where N is the total number of indicated NW operation states. If SSB is always present in a first NW operation state or a default NW operation state, a bitmap of size N−1 can be used to indicate the presence of SSB in other NW operation states. When SSB is present in a certain NW operation state for a serving cell, SSB transmission on the serving cell may be with reduced power and the power level can be indicated to the UE.

In one example, the gNB indicates to the UE a set of ss-PBCH-BlockPower values for each NW operation state. In another example, the gNB indicates to the UE a ss-PBCH-BlockPower value for a first NW operation state or a default NW operation state and indicates an offset with respect to the ss-PBCH-BlockPower value, e.g., ss-PBCH-BlockPowerOffset, for the other NW operation states for the serving cell. As an alternative to indicating SSB transmission power levels for different NW operation states, the gNB can indicate to the UE parameters related to L3 filtering for the UE to correctly compensate the SSB transmission power difference in combining the L1 measurements on the serving cell.

In one example, the gNB indicates to the UE a set of scaling factors, s₁, . . . , s_{N}, for N configured NW operation states. The scaling factor for the first NW operation state or the default NW operation state can be set to 1 by specification. In such case, the gNB can indicate N−1 scaling factors to the UE for other NW operation states. For example, the indication of scaling factors can be included in ssb-FilterConfig. If the UE performs L1 measurements during NW operation state k, the result of an L1 measurement is multiplied by the scaling factor sₖ prior to L3 filtering.

Further aspects on the L3 filtering with the scaling factors for NW operation states are described in step 1330. In another example, the gNB indicates to the UE a set of filter coefficients, k¹, . . . , k^{N}, for N configured NW operation states for the serving cell. For L1 measurements obtained in NW operation state l, the UE uses k^{l} as filter coefficient for L3 filtering. The ssb-FilterConfig signalling can include filter coefficients for multiple NW operation states. Further aspects on the L3 filtering operation with a set of filter coefficients for NW operation states are described in step 1330.

The UE performs measurements based on SSB receptions on a serving cell according to SMTC and NW operation state configuration as previously described, and calculates L1 SS-RSRP, RSRQ, and/or SINR 1320. If the UE was indicated by the gNB that SSB is not transmitted on the serving cell during a certain NW operation state k, the UE skips measurements based on SSB receptions on the serving cell in occasions within a SMTC window duration.

The UE performs L3 filtering of L1 measurements by compensating SSB transmission power offsets between different NW operation states, and uses the filtered measurement results for evaluation of reporting criteria or for measurement reporting (e.g., step 1330). In one example, if the gNB indicates to the UE for the serving cell a set of scaling factors, s₁, . . . , s_{N}, for N configured NW operation states, the L3 filtering is performed according to the following formula: Fₙ=(1−a)*Fₙ₋₁+sI(n)*a*Mₙ where: I(n) is the index of NW operation state for the serving cell that is used for the measurement Mₙ; and sI(n) is the scaling factor for NW operation state I(n) and the rest of the notations are same as previously described.

In another example, if the gNB indicates to the UE a set of filter coefficients, k¹, . . . k^{N}, for N configured NW operation states for the serving cell, the UE performs L3 filtering according to the following formula: Fₙ=(1−aI(n))*Fₙ₋₁+aI(n)*Mₙ where: I(n) is the index of NW operation state on the serving cells for the measurement Mₙ; and aI(n) is given by aI(n)=1/2^{(k′/4)}, where k′ is a short notation for k⁽ⁿ⁾. The rest of notations are same as previously described.

The UE uses the filtered measurement results for evaluation of reporting criteria or for measurement reporting when the UE is configured with more than one NW operation states. As an alternative to indicating to UE parameters related to L3 filtering, e.g., scaling factors or filter coefficients associated with NW operation states, and the UE performs L3 filtering using the indicated parameters, the UE may derive by itself a proper scaling factors or filter coefficients based on the indicated SSB transmission power levels.

In one example, a scaling factor sᵢ for NW operation state i can be derived as sᵢ=Pₜₓ, default/P_{tx, i}, where P_{tx, default} is the ss-PBCH-BlockPower value in linear scale indicated by gNB for a first NW operation state or a default NW operation state and P_{tx, i} is the ss-PBCH-BlockPower value in linear scale indicated by gNB for the NW operation state i. Similarly, the filter coefficients, kⁱ, can be derived by UE based on the indicated SSB transmission power levels for NW operation states. The same formulas as described above can be used by UE for L3 filtering while the scaling factors or filter coefficients are derived by the UE based on indicated SSB transmission power levels instead of explicit indication by serving gNB.

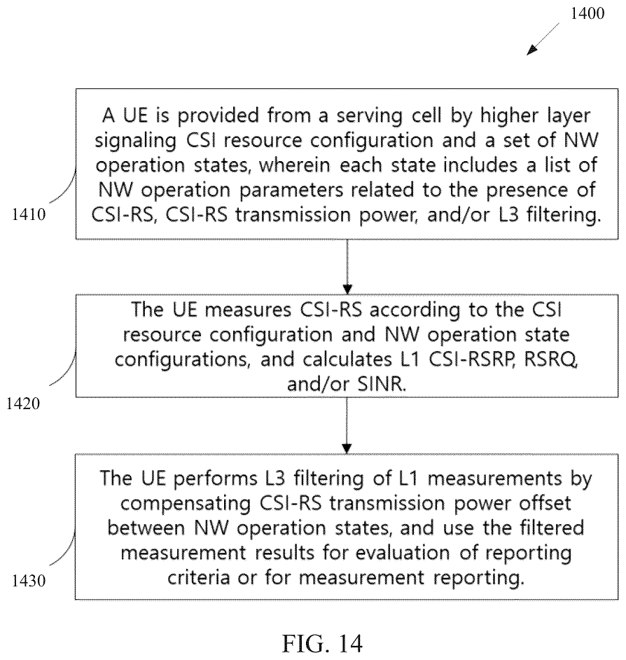

FIG. 14 illustrates a flowchart of UE procedure 1400 for L3 measurement enhancement with NW operation states for CSI-RS-based L1 measurements according to embodiments of the present disclosure. The UE procedure 1400 as may be performed by a UE (e.g., 111-116 as illustrated in FIG. 1). An embodiment of the UE procedure 1400 shown in FIG. 14 is for illustration only. One or more of the components illustrated in FIG. 14 can be implemented in specialized circuitry configured to perform the noted functions or one or more of the components can be implemented by one or more processors executing instructions to perform the noted functions.

FIG. 14 illustrates an example UE procedure to provide and for a UE to obtain an indication on NW operation parameters related to CSI-RS-based L1 measurement and L3 filtering, and for the UE to perform L1 measurements and L3 filtering prior to using the filtered measurement results for evaluation of reporting criteria or for measurement reporting, according to the disclosure. The overall framework is similar to the example procedure described in FIG. 13 except that the L1 measurements are performed on CSI-RS resources instead of SSBs. In the following, the differences in UE behavior between the two example procedures described in FIG. 13 and FIG. 14 are described.

A UE receives from a serving gNB by higher layer signaling CSI resource configuration, a set of NW operation states, and a list of associated NW operation parameters related to the presence of CSI-RS, CSI-RS transmission power offset and/or L3 filtering for a serving cell 1410. For a system without NW operation state adaptation, the UE may assume that CSI-RS is present during the indicated CSI-RS occasion per CSI resource configuration and downlink EPRE of a port of CSI-RS resource configuration is constant across the configured downlink bandwidth and constant across all configured OFDM symbols for the purpose of CSI-RSRP, CSI-RSRQ and CSI-SINR measurements on the serving cell.

For a system with NW operation state adaptation, the gNB may not transmit CSI-RS on the serving cell during the indicated CSI-RS occasion or transmit CSI-RS with reduced power on the serving cell. For a UE to perform L1 CSI-RSRP/RSRQ/SINR measurements and to correctly perform L3 filtering for the serving cells, the gNB indicates to the UE the presence of CSI-RS transmissions in a given NW operation state for the serving cell. The presence of CSI-RS can be indicated using a bitmap of size N, where N is the total number of indicated NW operation states. If CSI-RS is always present in a first NW operation state or a default NW operation state for the serving cell, a bitmap of size N−1 can be used for indicating the presence of CSI-RS in other NW operation states for the serving cell. While CSI-RS is present in a certain NW operation state, the gNB may transmit CSI-RS with a reduced transmission power on the serving cell and indicate the transmission power offset to the UE.

In one example, the gNB indicates to the UE a set of powerControlOffsetSS values for a set of indicated NW operation states for the serving cell. Each value indicates an offset of EPRE in dBm with respect to a ss-PBCH-BlockPower value that is indicated for the first NW operation state or the default NW operation state for the serving cell. In another example, the gNB indicates to the UE a set of powerControlOffsetSS values for a set of indicated NW operation states for the serving cell. Each value indicates an offset of EPRE in dBm with respect to the ss-PBCH-BlockPower value indicated for the corresponding NW operation state.

In another example, the gNB indicates to the UE a set of powerControlOffsetSS values for a set of indicated NW operation states for the serving cell. A first value, powerControlOffsetSS_1, is an offset of EPRE in dBm relative to the ss-PBCH-BlockPower value indicated for the first NW operation state or the default NW operation state and subsequent values, powerControlOffsetSS_2, . . . , powerControlOffsetSS_N, are offsets of EPRE in dBm with relative to the powerControlOffsetSS_1 value, where N is the total number of indicated NW operation states. Instead of indicating a CSI-RS transmission power offset for different NW operation states for the serving cell, the gNB may indicate to the UE parameters related to L3 filtering for the UE to correctly compensate the CSI-RS transmission power differences in combining the L1 measurements for the serving cell.

In one example, the gNB indicates to the UE a set of scaling factors, s₁, . . . , s_{N}, for N configured NW operation states for the serving cell. The scaling factor for the first NW operation state or the default NW operation state can be set to 1 by specification. In such case, the gNB can indicate to the UE N−1 scaling factors for other NW operation states for the serving cell. The scaling factors can be included in csi-RS-FilterConfig. If L1 measurements are performed during NW operation state k, the L1 measurement results are multiplied by the scaling factor sₖ, prior to L3 filtering operation. In another example, the gNB indicates to the UE a set of filter coefficients, k¹, . . . , k^{N}, for N configured NW operation states for the serving cell. For L1 measurements during NW operation state l, the UE uses k^{l} as filter coefficient for L3 filtering. For example, the csi-RS-FilterConfig signalling can include filter coefficients for multiple NW operation states.

The UE measures CSI-RS according to CSI resource configuration and NW operation state configuration as for the serving cell as previous described and calculates L1 CSI-RSRP, RSRQ, and/or SINR 1420. When the UE is indicated by the gNB that CSI-RS is not transmitted in a NW operation state k for the serving cell, the UE skips measuring CSI-RS on the serving cell during NW operation state k.

The UE performs L3 filtering of L1 measurements by compensating/adjusting for CSI-RS transmission power offsets between NW operation states, and uses the filtered measurement results for evaluation of reporting criteria or for measurement reporting 1430. The same formula and procedure that were previously described for SSB-based measurements apply in a similar manner for CSI-RS-based measurements.

The gNB may not transmit SSB and/or NZP CSI-RS on a certain serving cell in a certain NW operation state. In such case, the gNB can indicate to the UE an alternative cell that the UE can measure SSB and/or NZP CSI-RS when the given serving cell is in a certain NW operation state in which the SSB and/or NZP CSI-RS may not be transmitted. In another example, the gNB can indicate to the UE groups of cells, where joint RSRP measurements can be performed within a given group. The UE can perform L1 measurements on a first cell for a first NW operation state, on a second cell for a second NW operation state, and so on.

The pathloss increases as the carrier frequency increases. For example, the pathloss in free space is given by the free space pathloss (FSPL) formula, i.e., FSPL=(4π*d*f/c)², where d is the signal propagation distance, f is the carrier frequency, and c is the speed of light. If the UE derives L1 measurements from the alternative cell rather than from the target serving cell, the UE may compensate the pathloss difference in L1 RSRP/RSRQ/SINR measurements due to the difference in carrier frequency between the target serving cell and the alternative cell prior to perform L3 filtering.

As an example, for FSPL, if the carrier frequency of the target serving cell is f₁ and the carrier frequency of the alternative cell is f₂, the UE can compensate the L1 measurements obtained on the alternative cell by multiplying a factor β=(f₁/f₂)². The actual experienced pathloss exponent can be different from the exponent used in the FSPL model. In such case, the gNB can indicate to the UE the pathloss exponent, α, and the UE derives the compensation factor β=(f₁/f₂)^{a} and multiply the factors with L1 measurements obtained from the alternative cell prior to L3 filtering. In another example, the gNB can indicate to the UE the pathloss compensation factor β itself, and the UE compensates L1 measurements by multiplying the indicated factor β prior to L3 filtering.

The gNB can change the beam, for example, by applying different spatial filter which can result in different beam-widths and/or directions, for the transmission of SSB and/or NZP CSI-RS on a given serving cell as one method of NW operation adaptation. For example, the gNB can use wide beams for the transmission of SSB and/or NZP CSI-RS in one set of NW operation states and narrow beams in another set of NW operation states. When different spatial filters are applied, the measured L1 RSRP/RSRQ/SINR values can be different even if the signal is transmitted from the same TRP on the same serving cell with the same transmission power.

In such case, the gNB can indicate to the UE a set of NW operation states, in which the same beam characteristics can be assumed among states in the same set. The gNB can also indicate to the UE scaling factors between different sets of NW operation states. The UE can compensate L1 measurements obtained from different sets of NW operation states with different beam characteristics by multiplying the indicated scaling factors prior to the L3 filtering. Alternatively, the gNB can restrict the UE to perform L3 filtering only among the L1 measurements obtained from the same set of NW operation states. Accordingly, the UE can perform L3 filtering separately for different sets of NW operation states and maintain multiple L3 measurement values, each corresponding to different sets of NW operation states.

In another example, the gNB can indicate to the UE, or it can be defined by specification, such that the UE resets L3 filtering and starts a new process when the NW operation state changes from one set to another set, among which the same beam characteristics cannot be assumed. In another example, the gNB can indicate to the UE a TCI state or a set of possible TCI states for a given NW operation state. When more than one TCI states are indicated to the UE for a given NW operation state by higher layer signaling, the gNB can indicate to the UE an activation of a certain TCI state via MAC CE or DCI. When an active TCI state changes as the gNB changes the NW operation from one state to another, the UE can reset the L3 filtering and restart the process.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method for a user equipment (UE) to report channel state information (CSI), the method comprising:
receiving:
first information related to transmissions, from a base station (BS), of first reference signals (RSs) associated with respective first operation states on a first cell, wherein the first RSs include channel state information reference signals (CSI-RS) or synchronization signals,
second information related to computing first CSI reports from respective receptions of the first RSs on the first cell, and
the first RSs based on the first information;
determining, based on the second information, the first CSI reports corresponding to the respective receptions of the first RSs on the first cell; and
transmitting a channel with the first CSI reports.

2. The method of claim 1, further comprising:
receiving third information for a second operation state on the first cell, wherein:
the second operation state is not included in the first operation states, and
the second operation state is not associated with reception of respective second RSs.

3. The method of claim 1, wherein the first information includes transmission powers of the first RS from the BS.

4. The method of claim 1, wherein:
the second information includes parameters related to transmission powers of the first RS from the BS, and
the first CSI reports are determined based on the receptions of the first RSs by adjusting for differences in transmission powers of the first RSs.

5. The method of claim 1, further comprising:
receiving third information for a second operation state on the first cell, wherein:
the transmission of the channel with the first CSI reports occurs in operation states from the first operation states on the first cell, and
the transmission of the channel with the first CSI reports does not occur in the second operation state on the first cell.

6. The method of claim 1, further comprising:
receiving third information related to transmissions of second RSs on a second cell, wherein:
the second RSs are associated with the first operation states on the first cell,
the transmissions of the first RSs on the first cell and of the second RSs on the second cell are not overlapping in time, and
determining the first CSI reports further comprises determining the first CSI reports based on receptions of the first RSs on the first cell and of the second RSs on the second cell.

7. The method of claim 6, wherein determining the first CSI reports from receptions of the first RSs on the first cell and of the second RSs on the second cell includes adjusting measurements based on the second RSs on the second cell according to a difference between a pathloss associated with the first cell and a pathloss associated with the second cell.

8. A user equipment (UE) comprising:
a transceiver configured to receive:
first information related to transmissions, from abase station (BS), of first reference signals (RSs) associated with respective first operation states on a first cell, wherein the first RSs includes channel state information reference signals (CSI-RS) or synchronization signals,
second information related to computing first CSI reports from respective receptions of the first RSs on the first cell, and
the first RSs based on the first information; and
a processor operably coupled to the transceiver, the processor configured to determine, based on the second information, the first CSI reports corresponding to the respective receptions of the first RSs on the first cell,
wherein the transceiver further configured to transmit a channel with the first CSI reports.

9. The UE of claim 8, wherein:
the transceiver is further configured to receive third information for a second operation state on the first cell,
the second operation state is not included in the first operation states, and
the second operation state is not associated with reception of respective second RSs.

10. The UE of claim 8, wherein the first information includes transmission powers of the first RSs from the BS.

11. The UE of claim 8, wherein:
the second information includes parameters related to transmission powers of the first RSs from the BS, and
the processor is further configured to determine the first CSI reports based on the receptions of the first RSs by adjusting for differences in the transmission powers of the first RSs.

12. The UE of claim 8, wherein:
the transceiver is further configured to receive third information for a second operation state on the first cell,
the transmission of the channel with the first CSI reports occurs in operation states from the first operation states on the first cell, and
the transmission of the channel with the first CSI reports does not occur in the second operation state on the first cell.

13. The UE of claim 8, wherein:
the transceiver is further configured to receive third information related to transmissions of second RSs on a second cell,
the second RSs are associated with the first operation states on the first cell,
the transmissions of the first RSs on the first cell and of the second RSs on the second cell are not overlapping in time, and
the processor is further configured to determine the first CSI reports based on receptions of the first RSs on the first cell and of the second RSs on the second cell.

14. The UE of claim 13, wherein the processor is further configured to determine the first CSI reports from receptions of the first RSs on the first cell and of the second RSs on the second cell by adjusting measurements based on the second RSs on the second cell according to a difference between a pathloss associated with the first cell and a pathloss associated with the second cell.

15. A base station comprising:
a transceiver configured to:
transmit first information related to transmissions of first reference signals (RSs) associated with respective first operation states on a first cell, wherein the first RSs includes channel state information reference signals (CSI-RS) or synchronization signals;
transmit second information related to computing first CSI reports from respective receptions of the first RSs on the first cell;
transmit the first RSs based on the first information; and
receive a channel with the first CSI reports,
wherein the first CSI reports correspond to the first RSs on the first cell and are based on the second information.

16. The base station of claim 15, wherein:
the transceiver is further configured to transmit third information for a second operation state on the first cell,
the second operation state is not included in the first operation states, and
the second operation state is not associated with reception of respective second RSs.

17. The base station of claim 15, wherein the first information includes transmission powers of the first RSs.

18. The base station of claim 15, wherein:
the second information includes parameters related to transmission powers of the first RSs, and
the first CSI reports are based adjustment for differences in the transmission powers of the first RSs.

19. The base station of claim 15, wherein:
the transceiver is further configured to transmit third information for a second operation state on the first cell,
the reception of the channel with the first CSI reports occurs in operation states from the first operation states on the first cell, and
the reception of the channel with the first CSI reports does not occur in the second operation state on the first cell.

20. The base station of claim 15, wherein:
the transceiver is further configured to transmit third information related to transmissions of second RSs on a second cell,
the second RSs are associated with the first operation states on the first cell,
the transmissions of the first RSs on the first cell and of the second RSs on the second cell are not overlapping in time, and
the first CSI reports are based on the first RSs on the first cell and the second RSs on the second cell.
